(19) United States
(12) Patent Application Publication
(10) Pub. No.: US 2014/0016579 A1
(43) Pub. Date: Jan. 16, 2014

(54) INTERFERENCE PROCESS OF INTERFERENCE SIGNAL

(71) Applicant: International Business Machines Corporation, Armonk, NY (US)

(72) Inventors: Xinhao Cheng, Shanghai (CN); Yonghua Lin, Beijing (CN); Hang Liu, Beijing (CN); Jianbin Tang, Melbourne (AU); Jun Song Wang, Beijing (CN); Qing Wang, Beijing (CN); Xian Wei Yi, Beijing (CN); Zhen Bo Zhu, Beijing (CN)

(21) Appl. No.: 13/928,503

(22) Filed: Jun. 27, 2013

(30) Foreign Application Priority Data
Jun. 29, 2012 (CN) 201210224782.8

(51) Int. Cl. H04W 72/04

(52) U.S. Cl. CPC H04W 72/0453
USPC 370/329; 375/349

(57) ABSTRACT

This invention relates to wireless signal process, and discloses a method for interference process of an interference signal in an OFDM based wireless communication system, comprising: receiving an interference signal; performing time domain and frequency domain analyses on the interference signal to obtain interference characteristics of the interference signal; determining an interference category of the interference signal according to the interference characteristics of the interference signal; and performing interference process on the interference signal in view of the interference category of the interference signal. The method for interference signal process of this invention is effective to both homogeneous network interference and heterogeneous network interference, so that frequency spectrum sharing of homogeneous networks and existing heterogeneous networks can be realized.

### CROSS-REFERENCE TO RELATED APPLICATION

This application claims priority under 35 U.S.C. §119 from Chinese Patent Application No. 201210224782.8 filed Jun. 29, 2012, the entire contents of which are incorporated herein by reference.

### BACKGROUND OF THE INVENTION

1. Field of the Invention

The present invention relates to wireless signal process, and more specifically, to a method and device for interference process of an interference signal.

2. Description of the Related Art

Currently, wireless networks have gained wide applications, accompanied by interference between different wireless networks. In terms of mechanisms of forming interference, interference is commonly divided into homogeneous wireless network interference and heterogeneous wireless network interference. For example, interference between cells of GSM, CDMA and other cell mobile communication networks is homogeneous wireless network interference. Because the use of official licensed frequency bands, there is no heterogeneous interference coming from other wireless systems. Hence, it can be solved through static frequency spectrum planning with additional network optimization. However, as to interference in heterogeneous wireless networks, it shows significant diversity and complexity, for example, interference between various systems of wireless devices in some ISM frequency bands, or interference between new and obsolete devices in wireless network upgrading. Because it is hard to identify interference sources, formats, and characteristics, its interference process methods become relatively complicated.

Existing interference process solutions for heterogeneous wireless networks are not satisfying in terms of their implementation and effects. For example, multi-antenna techniques, by means of antenna orientations, can combine desired signal while suppressing an interference signal on the receiving side through suitable multi-antenna space weighting. However, such a solution needs multi-antenna equipments provided on receivers and involves complex signal process operations, having great difficulty in implementation and relatively higher cost, and thus, commonly adopted in military wireless communication systems. Besides, energy measurement solutions are widely used in networks, such as WiFi, WSN, etc, which are easier to implement, however, those solutions always adopt avoidance when interference is detected, as a result, they are unable to coexist with other systems, leading to lower frequency spectrum utilization, particularly, when there are larger amount of nodes, which may cause rapid degradation of total throughput.

Especially, in the use of scheduled wideband wireless communication systems having higher spectrum efficiency, such as WiMAX, LET systems, how to share frequency spectrum with existing heterogeneous wireless communication systems is still an unsolved problem. Furthermore, because heterogeneous wireless networks of different systems have entirely different formats and characteristics, it is difficult to find out a uniform and effective manner suitable to all kinds of interference.

Therefore, an interference process method which is effective to both homogeneous networks and heterogeneous networks is highly desirable.

### SUMMARY OF THE INVENTION

Based on the above issue, a method and device for interference process of an interference signal in an OFDM (Orthogonal Frequency Division Multiplexing) based wireless communication system are provided in this invention.

According to a first aspect of this invention, a method for interference process of an interference signal in an OFDM based wireless communication system is provided in this invention, comprising: receiving an interference signal; performing time domain and frequency domain analyses on the interference signal to obtain interference characteristics of the interference signal; determining an interference category of the interference signal according to the interference characteristics of the interference signal; and performing interference process on the interference signal in view of the interference category of the interference signal.

According to a second aspect of this invention, a device for interference process of an interference signal in an OFDM based wireless communication system is provided in this invention, comprising: a receiving module, configured to receive an interference signal; a time-domain and frequency-domain analysis module, configured to perform time domain and frequency domain analyses on the interference signal to obtain interference characteristics of the interference signal; a interference category determination module, configured to determine an interference category of the interference signal according to the interference characteristics of the interference signal; and an interference process module, configured to perform interference process on the interference signal in view of the interference category of the interference signal.

The method for interference process of an interference signal according to embodiments of this invention is effective for both homogeneous networks interference and heterogeneous networks interference, so that frequency spectrum sharing of homogeneous networks and existing heterogeneous networks can be realized.

### BRIEF DESCRIPTION OF THE DRAWINGS

With reference to the following detailed description of exemplary embodiments of the present disclosure in combination with the accompanying drawings, the invention per se, preferred embodiments thereof and the objects and advantages thereof will be better understood, wherein:

FIG. 1 shows an exemplary computer system which is applicable to implement the embodiments of the present invention.

FIG. 2 shows a wireless communication system according to an embodiment of this invention.

FIG. 3 shows a method for interference process of an interference signal in an OFDM based wireless communication system according to an embodiment of this invention.

FIG. 4 shows a process of a time-domain analysis performed on a digital baseband signal.

FIG. 5 shows a process of a frequency-domain analysis performed on a digital baseband signal.

FIG. 6 shows a schematic diagram of mapping an interference signal to subbands according to an embodiment of this invention.

FIG. 7 shows an example of encoding interference indication information with a bitmap.

FIG. 8 shows a device 800 for interference process of an interference signal in an OFDM based wireless communication system according to an embodiment of this invention.

### DETAILED DESCRIPTION OF THE PREFERRED EMBODIMENT

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

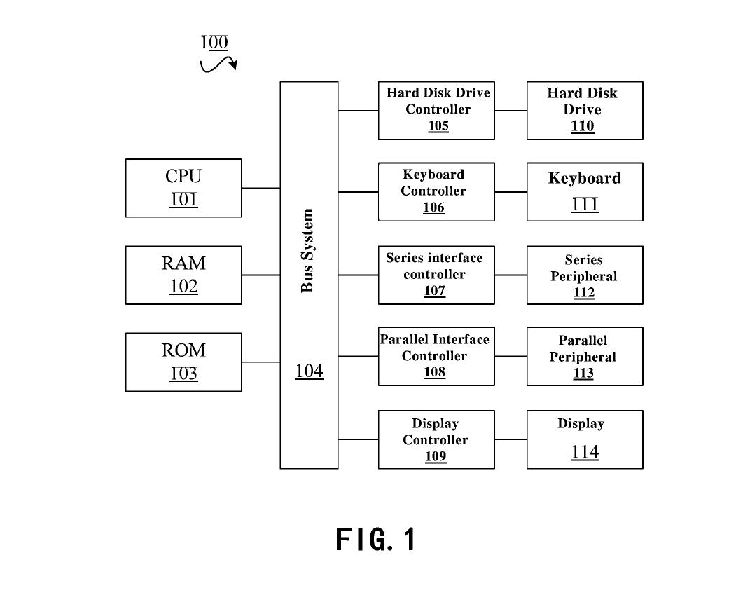

FIG. 1 shows an exemplary computer system 100 which is applicable to implement the embodiments of the present invention. As shown in FIG. 1, the computer system 100 may include: CPU (Central Process Unit) 101, RAM (Random Access Memory) 102, ROM (Read Only Memory) 103, System Bus 104, Hard Drive Controller 105, Keyboard Controller 106, Serial Interface Controller 107, Parallel Interface Controller 108, Display Controller 109, Hard Drive 110, Keyboard 111, Serial Peripheral Equipment 112, Parallel Peripheral Equipment 113 and Display 114. Among above devices, CPU 101, RAM 102, ROM 103, Hard Drive Controller 105, Keyboard Controller 106, Serial Interface Controller 107, Parallel Interface Controller 108 and Display Controller 109 are coupled to the System Bus 104. Hard Drive 110 is coupled to Hard Drive Controller 105. Keyboard 111 is coupled to Keyboard Controller 106. Serial Peripheral Equipment 112 is coupled to Serial Interface Controller 107. Parallel Peripheral Equipment 113 is coupled to Parallel Interface Controller 108. And, Display 114 is coupled to Display Controller 109. It should be understood that the structure as shown in FIG. 1 is only for the exemplary purpose rather than any limitation to the present invention. In some cases, some devices may be added to or removed from the computer system 100 based on specific situations.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

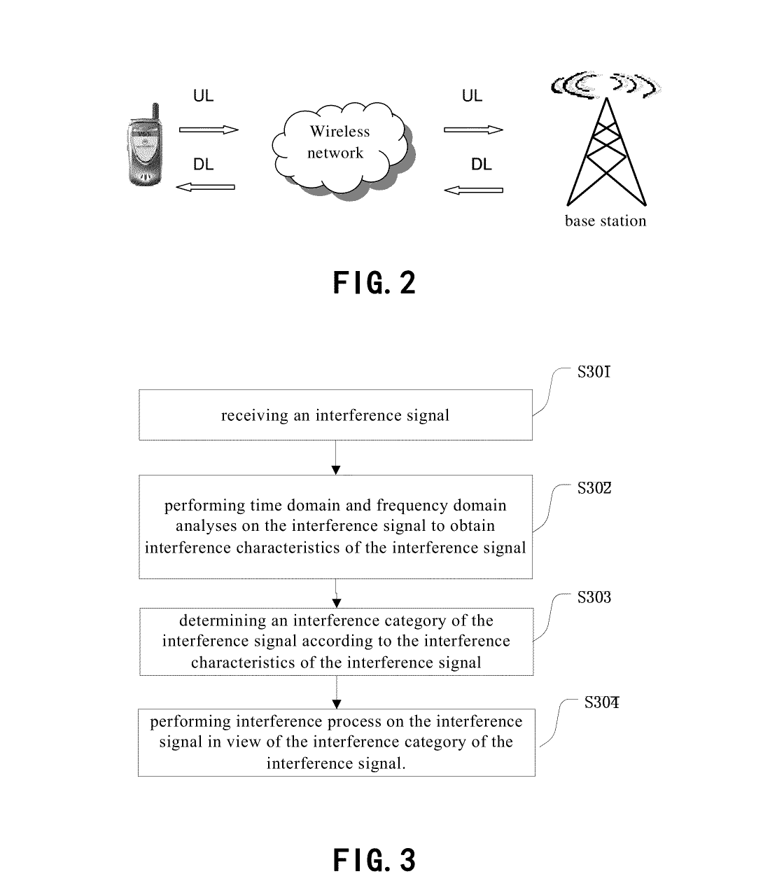

FIG. 2 shows a wireless communication system according to an embodiment of this invention. According to the embodiment of this invention, the wireless communication system is realized to employ the OFDM communication protocol on its physical layer, which is a widely adopted technique in wireless communication systems, with an essential idea of dividing a channel into several orthogonal subbands, and converting a high rate data signal into parallel low rate sub-data streams, which are modulated on respective subbands to transmit, allowing a base station and mobile terminals the system belongs to, to transmit data on those subbands. According to an embodiment of this invention, the wireless communication system comprises a base station and mobile terminals, wherein the base station and mobile terminals communicate through a wireless network, and operate in one wireless frequency band. According to the embodiment of this invention, interference signals produced on an uplink (UL) from a mobile terminal to the base station can be processed. Those skilled in the art may understand that the method for interference signal process of the embodiment of this invention is applicable to any wireless communication system adopting the OFDM communication protocol, such as, wireless communication systems in conformity with the IEEE802.11g standard, but not limited to wireless communication systems consisted of a base station and mobile terminals.

FIG. 3 shows a method for interference process of an interference signal in an OFDM based wireless communication system according to an embodiment of this invention, comprising: receiving an interference signal at step S301; at step S302, performing time-domain and frequency-domain analyses on the interference signal to obtain interference characteristics of the interference signal; at step S303, determining an interference category according to the interference characteristics of the interference signal; at step S304, performing interference process on the interference signal in view of the determined interference category.

According to the embodiment of this invention, the method further comprises classifying interference categories according to interference characteristics in advance. According to the embodiment of this invention, interference categories comprise: resistible interference, avoidable interference, and periodic interference.

According to the embodiment of this invention, if interference characteristics indicate that the interference has a wider bandwidth and a lower interference power, or a narrower bandwidth and a medium interference power, it is determined that the interference category is resistible interference, particularly, a method of determining resistible interference according to an embodiment of this invention comprises: predefining a first threshold of the ratio of interference signal energy and signal energy, and a second threshold of the ratio of interference bandwidth and total signal bandwidth; comparing the ratio of interference signal energy and signal energy with the first threshold, and comparing the ratio of interference bandwidth and total signal bandwidth with the second threshold, and determining whether there is resistible interference according to the comparison result. For example, the first threshold is 10 dB, the second threshold is 30%, wherein if the ratio of interference signal energy and signal energy is less than 10 dB, and the ratio of interference bandwidth and total signal bandwidth of the wireless signal is larger than 30%, it indicates that the wireless signal has a wider interference bandwidth and lower interference power, and thus, the interference category is resistible interference. For example, the first threshold is 10 dB˜20 dB, the second threshold is 10%, if the ratio of interference signal energy and signal energy is within a range of 10 dB˜20 dB, and the ratio of interference bandwidth and total signal bandwidth of the wireless signal is less than 10%, it indicates that the wireless signal has a narrower interference bandwidth and medium interference power, and thus, the interference category is resistible interference.

According to the embodiment of this invention, if interference characteristics indicate narrowband interference and stronger interference power, it can be determined that the interference is in the category of avoidable interference. The above method of determining resistible interference can be referenced for the method of determining avoidable interference. Particularly, according to an embodiment of this invention, a first threshold of the ratio of interference signal energy and signal energy, and a second threshold of the ratio of interference bandwidth and total signal bandwidth are predefined; the ratio of interference signal energy and signal energy is compared with the first threshold, and the ratio of interference bandwidth and total signal bandwidth is compared with the second threshold, to determine whether there is avoidable interference according to the comparison result. If the ratio of interference signal energy and signal energy is larger than the first threshold, and the ratio of interference bandwidth and total signal bandwidth is less than the second threshold, it indicates narrow-band interference with strong interference power. For example, the first threshold is 20 dB, the second threshold is 10%, wherein the ratio of interference signal energy and signal energy is larger than 20 dB, if the ratio of interference bandwidth and total bandwidth is less than 10%, it indicates that the wireless signal is narrow-band interference with strong interference power, and thus the interference category is avoidable interference.

According to the embodiment of this invention, interference categories further comprise instantaneous bursty interference. If interference characteristics indicate an interference signal with longer time intervals and short duration, the category can be determined as instantaneous bursty interference. For example, instantaneous bursty interference can be determined according to occurrence probability of the interference signal.

According to the embodiment of this invention, if interference characteristics indicate that the interference signal has a constant time interval and duration, and exhibits a periodic characteristic, the interference category can be determined as periodic interference.

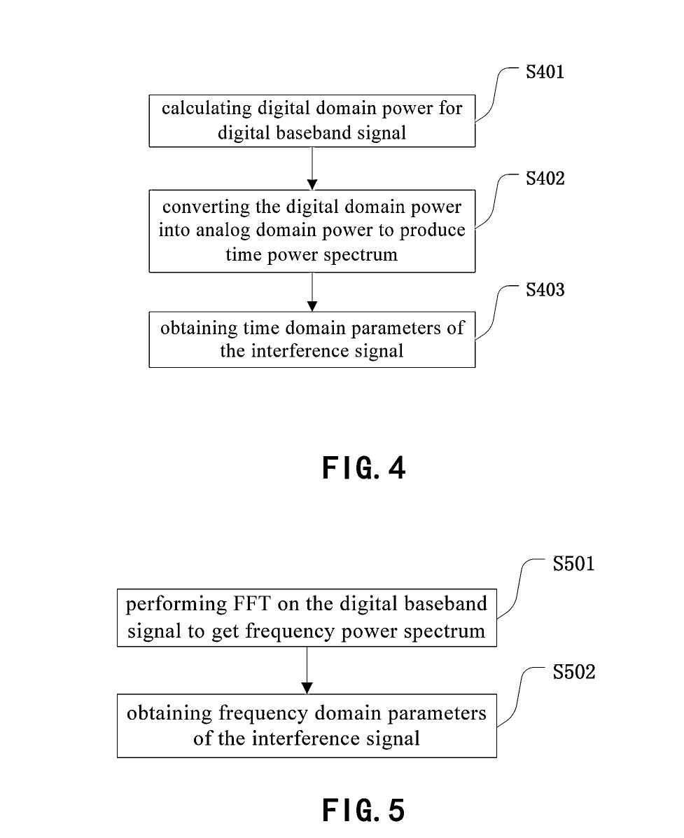

At step S302, the interference signal received from an antenna is first down-converted and ADC (analog to digital) converted to get a digital baseband signal; then time-domain and frequency-domain analyses are performed on the digital baseband signal. FIG. 4 shows a process of performing time-domain analysis on a digital baseband signal. At step S401, digital domain power is calculated for the digital baseband signal. At step S402, the digital domain power is converted into analog domain power to produce time power spectrum. At step S403, time domain parameters of the interference signal are obtained, including interference power, interference duration, interference occurrence probability, interference occurrence interval. FIG. 5 shows a process of performing frequency domain analysis on the digital baseband signal. At step S501, FFT (Fast Fourier Transform) is carried on the digital baseband signal to get frequency power spectrum. At step S502, frequency domain parameters of the interference signal are obtained, including center frequency, bandwidth, and power spectral density.

At step S303, an interference category is determined according to interference characteristics of the interference signal, that is, which one of the above four categories the interference signal belongs to is determined based on time-domain parameters and frequency-domain parameters of the interference signal obtained at step S302. Particularly, for the method of determining resistible interference and avoidable interference with frequency domain parameters of the interference signal, a reference can be made to the method of classifying resistible interference and avoidable interference in the interference category classification of the interference signal, which will not be described in detail. Instantaneous bursty interference can be determined with interference occurrence probability, and periodic interference can be determined with interference occurrence interval.

At step S305, interference process is performed on the interference signal based on the determined interference category.

According to the embodiment of this invention, in response to determining that the interference category of the interference signal is resistible interference, the base station can increase transmission power of the mobile terminal through closed loop power control to resist the interference signal. Such an interference process method has no frequency resource sacrifice and no impact on throughput.

According to the embodiment of this invention, in response to determining that the interference category of the wireless interference signal is avoidable interference, the base station generates interference indication information according to frequency occupation of the interference signal in a wireless frequency band; sends the interference indication information to a resource scheduler in an upper layer of its protocol stack; transmits the interference indication information to the mobile terminal through a downlink control channel; and the resource scheduler instructs the mobile terminal to avoid frequencies having interference thereon when allocating frequencies to the mobile terminal.

Generating interference indication information according to frequency occupation of the interference signal in a wireless frequency band further comprises: dividing the wireless frequency band into several subbands; mapping bandwidth of the interference signal to the several subbands; encoding subband occupation of the interference signal in the wireless frequency band to generate interference indication information.

Transmitting the interference indication information to the mobile terminal through a downlink control channel further comprises: providing the interference indication information in a control word of a downlink frame to be sent to the mobile terminal to broadcast in-band interference indication information, enabling the mobile terminal to avoid in-band interference, so that discontinuous frequency spectrums in the frequency band can be sufficiently utilized as well, further improving frequency spectrum efficiency.

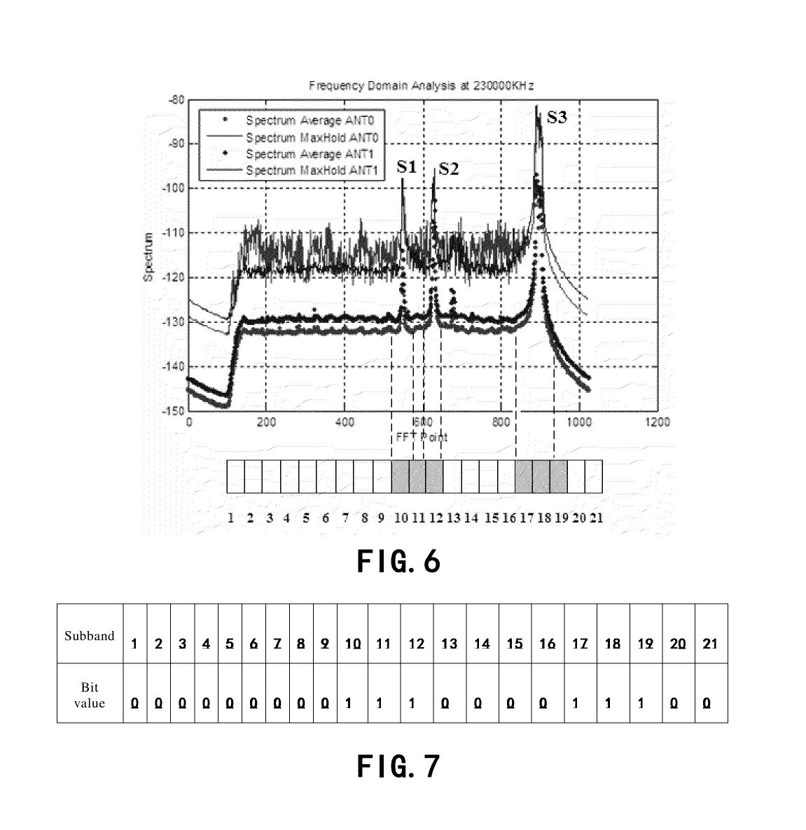

FIG. 6 shows a schematic diagram of mapping the interference signal to subbands according to an embodiment of this invention, the upper portion of FIG. 6 shows frequency domain power spectrum obtained through frequency analysis performed on the digital baseband signal. As shown, the wireless band has a bandwidth of 1.034 MHz, which is divided into 21 subbands according to the embodiment of this invention, each of which is 49.2 KHz. The number of subbands can be determined as appropriate, and those skilled in the art may appreciate that the more the number of subbands is, the more accurately the interference indication information can be represented. Dashed lines in FIG. 6 further show that an interference signal S1 falls within subbands 10 and 11, an interference signal S2 falls within subbands 11 and 12, and an interference signal S3 falls within subbands 17, 18, and 19.

Subband occupation of an interference signal in a wireless frequency band can be represented through various encoding manners. As a simple encoding manner, a bitmap can be adopted. For example, a bitmap shown in FIG. 7 can be adopted as the interference indication information to indicate subband occupation of the interference signal as shown in FIG. 6. Twenty-one bits 1, 2, . . . , 21 of the bitmap respectively represent the above twenty-one subbands 1, 2, . . . , 21, and the value of each bit represents whether there is any interference signal on a subband represented by that bit, for example, value “1” on bits 10, 11, 12, 17, 18, 19 represent there are interference signal on subbands 10, 11, 12, 17, 18, 19, while value “0” on bits 1, 2, 3, 4, 5, 6, 7, 8, 9, 13, 14, 15, 16 represent there is not any interference signal on subbands 1, 2, 3, 4, 5, 6, 7, 8, 9, 13, 14, 15, 16. The above bitmap is merely a simple encoding manner for indicating interference indication information. Obviously, this invention is not limited thereto. As described above, those skilled in the art can adopt any other encoding manner to represent which subbands are occupied, that is, interference indication information.

According to the embodiment of this invention, the base station provides the above interference indication information in a control word of a downlink frame to be transmitted to a mobile terminal. In many standard-compliant wireless communication systems, such as WiMAX systems and LTE systems, usually there are reserved bits provided in control words of a downlink frame. Thus, it is benefit to provide interference indication information using reserved bits of a control word. According to an embodiment of this invention, the wireless communication system the base station belongs to is a WiMAX-compliant system. In such a case, the control word of a downlink frame mentioned at step S422 is FCH (Forward Control Header) of a WiMAX-compliant downlink frame.

In addition to WiMAX systems, this invention can be realized on other OFDM based wireless communication systems. For example, LTE systems are one kind of OFDM based wireless communication systems. Similar to WiMAX systems, a downlink frame of a LTE system comprises FCH-analogous control words, for example, PDCCH (Physical Downlink Control Channel) and PBCH (Physical Broadcast Channel), in which some free bits such as reserved bits are also available. Obviously, according to the description of providing interference indication information in FCH above, it is easy for those skilled in the art to provide interference indication information in the available bits of PDCCH and/or PBCH.

According to an embodiment of this invention, in response to determining that the interference category of the interference signal is instantaneous bursty interference, because instantaneous bursty interference has limited impact on system performances, no measures are needed to process.

According to an embodiment of this invention, in response to determining that the interference category of the interference signal is periodic interference, a periodic parameter characteristic of the interference signal is obtained. Particularly, a periodic parameter characteristic of the interference signal can be obtained through time-power spectrum analysis of periodic interference. According to the periodic parameter characteristic of the interference signal, measures can be adopted before the occurrence of the interference signal to avoid interference, and the communication state can be restored after the disappearance of the interference signal, so that power consumption/bandwidth losses can be prevented. With respect to the particular process method, resistible or avoidable interference process methods described above can be adopted according to interference characteristics.

According to an embodiment of this invention, the method for interference process of an interference signal in an OFDM based wireless communication system can be realized on the BS (Base Station) side.

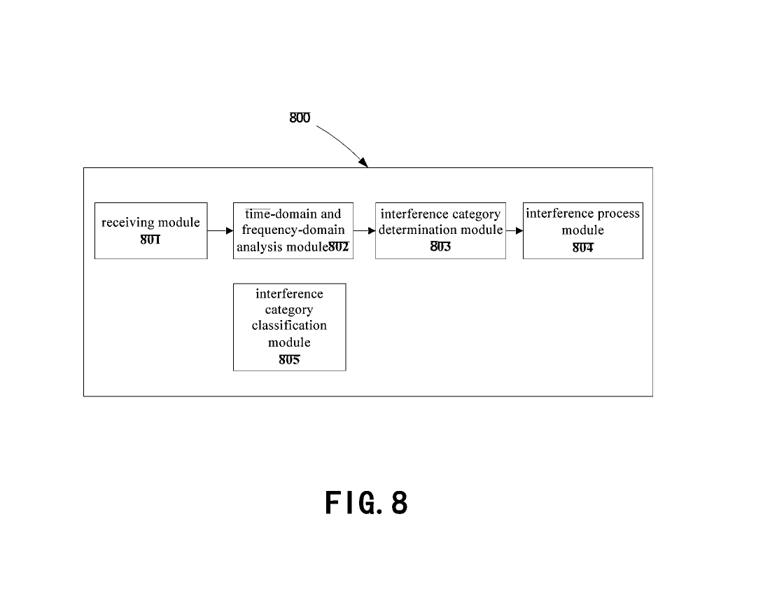

Based on the same inventive concept, a device for interference process of an interference signal in an OFDM based wireless communication system is provided in this invention. According to the embodiment, the device can be realized as a functional plug-in on the BS side. FIG. 8 shows a device 800 for interference process of an interference signal in an OFDM based wireless communication system, comprising: a receiving module 801, configured to receive interference signal; a time-domain and frequency-domain analysis module 802, configured to perform time domain and frequency domain analyses on the interference signal to obtain interference characteristics of the interference signal; a interference category determination module 803, configured to determine an interference category of the interference signal according to the interference characteristics of the interference signal; and an interference process module 804, configured to perform interference process on the interference signal in view of the interference category of the interference signal.

According to the embodiment of this invention, the device 800 further comprise interference category classification module 805, configured to classify an interference signal into several interference categories according to their interference characteristics.

According to the embodiment of this invention, the interference categories comprise: resistible interference, avoidable interference, and periodic interference.

According to the embodiment of this invention, the interference process module 804 further comprises a resistible interference process module, configured to, in response to determining that the interference category of the interference signal is resistible interference, increase transmission power of a mobile terminal through closed loop power control.

According to the embodiment of this invention, the interference process module 804 further comprises an avoidable interference process module, comprising: an interference indication information generating module, configured to in response to determining that the interference category of the interference signal is avoidable interference, generate interference indication information according to frequency occupation of the interference signal in a wireless frequency band; an interference indication information sending module, configured to send the interference indication information to an resource scheduler in an upper layer of its protocol stack, and transmit the interference indication information to a mobile terminal through a downlink control channel; and an interfered frequency avoiding module, configured to instruct the mobile terminal to avoid frequency bands having interference thereon when the resource scheduler allocates frequency bands to the mobile terminal.

According to the embodiment of this invention, the interference indication information generating module is further configured to: divide a wireless frequency band into multiple subbands; map a bandwidth of the interference signal to the multiple subbands; encode subband occupation of the interference signal in the wireless frequency band to generate interference indication information.

According to the embodiment of this invention, the interference indication information sending module is further configured to provide the interference indication information in a control word of a downlink frame sent to the mobile terminal.

According to the embodiment of this invention, the wireless communication system is a WiMAX system, wherein the control word of a downlink frame is FCH of a WiMAX downlink frame.

According to the embodiment of this invention, the wireless communication system is a LET system, wherein the control word of a downlink frame is PDCCH of a LTE downlink frame.

According to the embodiment of this invention, the interference process module 804 further comprises a periodic interference process module, configured to, in response to determining that the interference category of the interference signal is periodic interference, obtain a periodic parameter characteristic of the interference signal; according to the periodic parameter characteristic of the interference signal, adopt avoidance measures before the occurrence of the interference signal and restore the communication state after the disappearance of the interference signal to effectively avoid interference.

The method and apparatus for interference process of an interference signal according to embodiments of this invention can process interference in both homogeneous networks and heterogeneous networks, and are effective to both homogeneous network interference and heterogeneous network interference, so that frequency spectrum sharing can be realized for homogeneous networks and heterogeneous networks. In wireless communication system upgrading, new deployed wideband wireless system can share frequency spectrum with old narrowband wireless communication systems without the need of applying additional spectrum resources.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for interference process of an interference signal in an OFDM (Orthogonal Frequency Division Multiplexing) based wireless communication system, comprising:
receiving an interference signal;
performing time domain and frequency domain analyses on the interference signal to obtain interference characteristics of the interference signal;
determining an interference category of the interference signal according to the interference characteristics of the interference signal; and
performing interference process on the interference signal in view of the interference category of the interference signal.

2. The method according to claim 1, further comprising classifying interference categories for interference signals according to interference characteristics in advance.

3. The method according to claim 2, wherein the interference categories comprise: resistible interference, avoidable interference, and periodic interference.

4. The method according to claim 3, wherein performing interference process on the interference signal in view of the interference category of the interference signal further comprises:
in response to determining that the interference category of the interference signal is resistible interference, increasing transmission power of a mobile terminal through closed loop power control.

5. The method according to claim 3, wherein performing interference process on the interference signal in view of the interference category of the interference signal further comprises:
in response to determining that the interference category of the interference signal is avoidable interference, generating interference indication information according to frequency occupation of the interference signal in a wireless frequency band;
sending the interference indication information to a resource scheduler in an upper layer of its protocol stack;
transmitting the interference indication information to a mobile terminal through a downlink control channel; and
instructing the mobile terminal to avoid frequencies having interference thereon when the resource scheduler allocates frequencies to the mobile terminal.

6. The method according to claim 5, wherein generating interference indication information according to frequency occupation of the interference signal in a wireless frequency band further comprises:
dividing the wireless frequency band into several subbands;
mapping bandwidth of the interference signal to the several subbands;
encoding subband occupation of the interference signal in the wireless frequency band to generate interference indication information.

7. The method according to claim 5, wherein transmitting the interference indication information to the mobile terminal through a downlink control channel further comprises:
providing the interference indication information in a control word of a downlink frame to be sent to the mobile terminal.

8. The method according to claim 7, wherein the wireless communication system is a WiMAX system, and the control word of a downlink frame is FCH (Forward Control Header) of a WiMAX downlink frame.

9. The method according to claim 7, wherein the wireless communication system is a LET system, wherein the control word of a downlink frame is PDCCH (Physical Downlink Control Channel) of a LTE downlink frame.

10. The method according to claim 3, wherein performing interference process on the interference signal in view of the interference category of the interference signal further comprises:
in response to determining that the interference category of the interference signal is periodic interference, obtaining a periodic parameter characteristic of the interference signal;
according to the periodic parameter characteristic of the interference signal, adopting avoidance measures before the occurrence of the interference signal and restoring the communication state after the disappearance of the interference signal.

11. A device for interference process of an interference signal in an OFDM based wireless communication system, comprising:
a receiving module, configured to receive interference signal;
a time-domain and frequency-domain analysis module, configured to perform time domain and frequency domain analyses on the interference signal to obtain interference characteristics of the interference signal;
an interference category determination module, configured to determine an interference category of the interference signal according to the interference characteristics of the interference signal; and
an interference process module, configured to perform interference process on the interference signal in view of the interference category of the interference signal.

12. The device according to claim 10, further comprising an interference category classification module, configured to classify interference categories for interference signals according to interference characteristics in advance.

13. The device according to claim 12, wherein the interference categories comprise: resistible interference, avoidable interference, and periodic interference.

14. The device according to claim 13, wherein the interference process module further comprises a resistible interference process module, configured to, in response to determining that the interference category of the interference signal is resistible interference, increase transmission power of a mobile terminal through closed loop power control.

15. The device according to claim 13, wherein the interference process module further comprises an avoidable interference process module, comprising:
an interference indication information generating module, configured to in response to determining that the interference category of the interference signal is avoidable interference, generate interference indication information according to frequency occupation of the interference signal in a wireless frequency band;
an interference indication information sending module, configured to send the interference indication information to an resource scheduler in an upper layer of its protocol stack, and transmit the interference indication information to a mobile terminal through a downlink control channel; and
an interfered frequency avoiding module, configured to cause the resource scheduler to instruct the mobile terminal to avoid frequencies having interference thereon when allocating frequencies to the mobile terminal.

16. The device according to claim 15, wherein the interference indication information generating module is further configured to:
divide a wireless frequency band into multiple subbands;
map a bandwidth of the interference signal to the multiple subbands;
encode subband occupation of the interference signal in the wireless frequency band to generate interference indication information.

17. The device according to claim 15, wherein the interference indication information sending module is further configured to provide the interference indication information in a control word of a downlink frame sent to the mobile terminal.

18. The device according to claim 17, wherein the wireless communication system is a WiMAX system, wherein the control word of a downlink frame is FCH of a WiMAX downlink frame.

19. The device according to claim 17, wherein the wireless communication system is a LET system, wherein the control word of a downlink frame is PDCCH of a LTE downlink frame.

20. The device according to claim 13, wherein the interference process module further comprises a periodic interference process module, configured to:
in response to determining that the interference category of the interference signal is periodic interference, obtain a periodic parameter characteristic of the interference signal;
according to the periodic parameter characteristic of the interference signal, adopt avoidance measures before the occurrence of the interference signal and restore the communication state after the disappearance of the interference signal.
